(19) United States
(12) Patent Application Publication
(10) Pub. No.: US 2013/0280961 A1
(43) Pub. Date: Oct. 24, 2013

(54) EAR JACK OF MOBILE TERMINAL

(71) Applicant: SAMSUNG ELECTRONICS CO., LTD., Gyeonggi-do (KR)

(72) Inventor: Yongwon CHO, Gyeongsangbuk-do (KR)

(73) Assignee: Samsung Electronics Co., Ltd., Gyeonggi-do (KR)

(21) Appl. No.: 13/864,378

(22) Filed: Apr. 17, 2013

(30) Foreign Application Priority Data
Apr. 18, 2012 (KR) 10-2012-0040445

(51) Int. Cl. H01R 13/52; H01R 43/18

(52) U.S. Cl. CPC H01R 13/521; H01R 43/18
USPC 439/660; 29/874

(57) ABSTRACT

An ear jack of a mobile terminal for preventing a foreign substance from being injected into the mobile terminal includes: a body for forming a passage for inserting an earphone and for housing a plurality of metal terminals; and a foreign substance injection prevention layer made of an elastic material for preventing a foreign substance from being injected into the mobile terminal.

### CLAIM OF PRIORITY

This application claims the benefit under 35 U.S.C. §119(a) from an earlier Korean patent application filed on Apr. 18, 2012 in the Korean Intellectual Property Office and assigned Serial No. 10-2012-0040445, the entire disclosure of which is hereby incorporated by reference.

### BACKGROUND OF THE INVENTION

1. Field of the Invention

The present invention relates to an ear jack of a mobile terminal, and more particularly, to an ear jack of a mobile terminal for preventing a foreign substance from being introduce inside the mobile terminal.

2. Description of the Related Art

FIG. 1 is a cross-sectional view illustrating a conventional mobile terminal having an ear jack.

As shown, an inserting opening 1 of an ear jack 10 is exposed to the outside environment which in turn causes foreign substances such as rainwater, a dust, and other form of liquid to be introduced thereto. The ear jack 10 is generally made of a hard material (e.g., poly carbonate (PC)) such as plastic, and a gap 3 occurs between the ear jack 10 and a mobile terminal case. Therefore, in the conventional mobile terminal, a foreign substance such as rainwater can be injected into the mobile terminal through the gap 3. More specifically, a foreign substance may be injected into the mobile terminal through a path indicated by an arrow of FIG. 1.

In order to prevent the foreign substance, a subsidiary material 2 such as rubber is additionally attached between the ear jack 10 and the mobile casing. As a result, the manufacturing process is complicated and a cost increases due to the incorporation of the subsidiary material 2. Further, a failure rate in which the subsidiary material 2 is omitted, or the subsidiary material 2 is not properly attached to an accurate position is relatively high. Also, due to weakened adhesive strength of a double-sided tape that attaches the subsidiary material 2 over time, a problem of separation of the subsidiary material 2 from its attached house casing occurs.

### SUMMARY OF THE INVENTION

The present invention has been made in view of the above problems by providing g an ear jack of a mobile terminal that can effectively prevent a foreign substance from being injected into the mobile terminal.

The present invention further provides an ear jack of a mobile terminal in which a foreign substance injection prevention layer is integrally formed.

The present invention further provides an ear jack of a mobile terminal that can reduce a production cost of the mobile terminal by simplifying a manufacture process of the mobile terminal.

In accordance with an aspect of the present invention, an ear jack of a mobile terminal includes: a body for forming a passage for inserting an earphone and for installing a plurality of metal terminals; and a foreign substance injection prevention layer made of an elastic material for preventing a foreign substance from being introduced into the mobile terminal and for substantially enclosing outer area of the body.

### BRIEF DESCRIPTION OF THE DRAWINGS

The above features and advantages of the present invention will be more apparent from the following detailed description in conjunction with the accompanying drawings, in which:

FIG. 1 is a perspective view and a cross-sectional view illustrating a conventional mobile terminal having an ear jack;

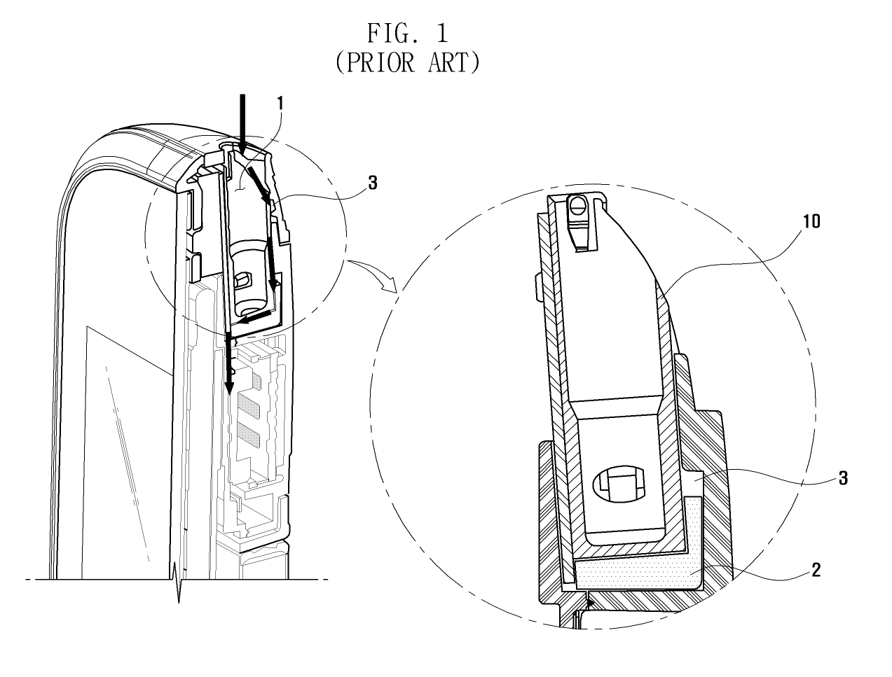

FIG. 2 is a perspective view illustrating an external appearance of an ear jack according to an exemplary embodiment of the present invention;

FIG. 3 is a cross-sectional view illustrating an example of fastening the ear jack of FIG. 2 to a mobile terminal; and

FIG. 4 is a flowchart illustrating a method of manufacturing the ear jack of FIG. 2.

### DETAILED DESCRIPTION OF EXEMPLARY EMBODIMENTS

Hereinafter, exemplary embodiments of the present invention are described in detail with reference to the accompanying drawings. The same reference numbers are used throughout the drawings to refer to the same or like parts. The views in the drawings are schematic views only, and are not intended to be to scale or correctly proportioned. For the purposes of clarity and simplicity, detailed descriptions of well-known functions and structures incorporated herein may be omitted to avoid obscuring the subject matter of the present invention.

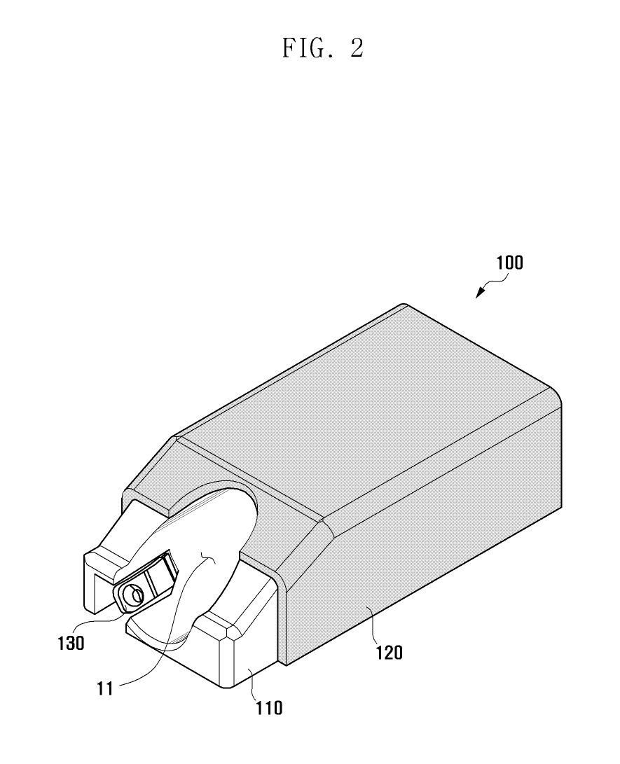

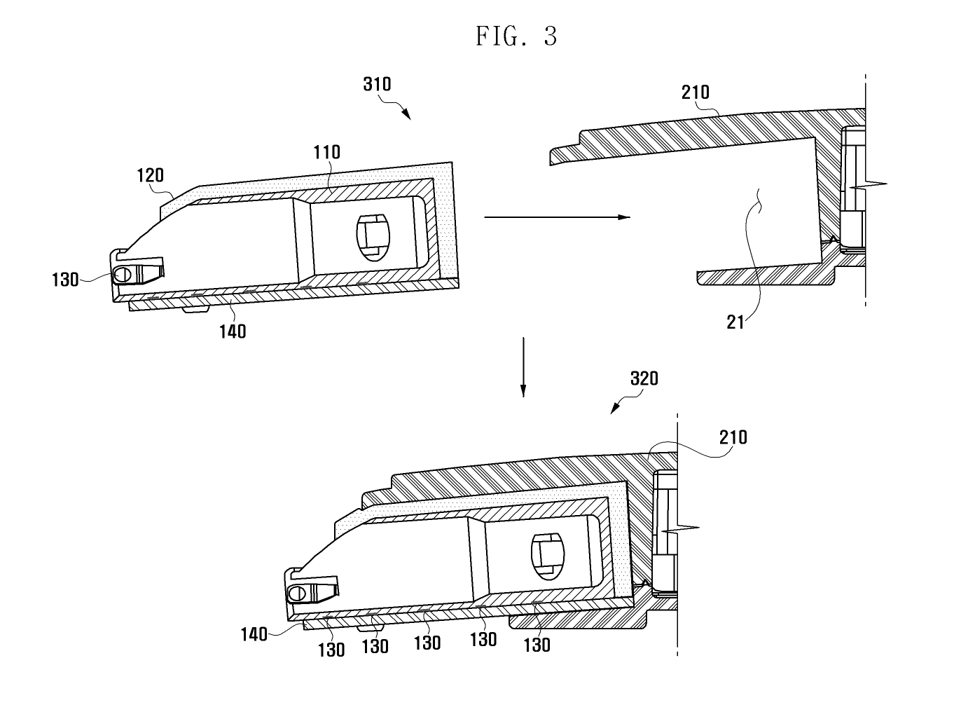

FIG. 2 is a perspective view illustrating an external appearance of an ear jack according to an exemplary embodiment of the present invention, and FIG. 3 is a cross-sectional view illustrating an example of fastening the ear jack of FIG. 2 to a mobile terminal.

Referring to FIGS. 2 and 3, an ear jack 100 according to an exemplary embodiment of the present invention includes a body 110 for forming an earphone inserting portion 11 or opening, which is an insertion passage of an earphone (not shown) and a foreign substance injection prevention layer (or elastic layer) 120 for enclosing at least a portion of the body 110. Further, although only a portion is illustrated in FIG. 2, the body 110 includes a plurality of metal terminals 130 contacting with an earphone (not shown). For example, the body 110 may include a left sound terminal for outputting a left sound signal, a right sound terminal for outputting a right sound signal, a microphone terminal for receiving a microphone signal, a ground terminal, and a detection terminal for recognizing insertion/removal of the earphone. Such metal terminals 130 are installed according to an ear jack standard specification. In this case, the metal terminal 130 and the body 110 are integrally produced through double injection molding or insert injection molding.

The body 110 has a cuboid shape and includes an upper surface in which an inlet for inserting the earphone is formed, a bottom surface opposite to the upper surface, an upper end surface, a lower end surface, a left side surface, and a right side surface. Such a body 110 is made of a plastic material (e.g., poly carbonate (PC), and the metal terminal 130 is made of a metal having good conductibility such as copper and gold. However, the present invention is not limited thereto and it will become apparent to a person of common skill in the art that various other materials may be used.

The foreign substance injection prevention layer 120 encloses at least a portion of the body 110 and serves to prevent any foreign substance (e.g., rainwater, dust, or drinking water) from being injected or introduced into the mobile terminal. In this case, it is preferable that the foreign substance injection prevention layer 120 is made of a material having elasticity. For example, the foreign substance injection prevention layer 120 may be made of urethane, rubber, and silicon rubber materials. However, the present invention is not limited thereto. That is, it will become apparent to a person of common skill in the art that the foreign substance injection prevention layer 120 may be made of various other materials with elasticity and having a waterproof function.

The foreign substance injection prevention layer 120 may be integrally formed with the body 110 through double injection molding. The foreign substance injection prevention layer 120 may be formed to enclose a left side surface, a right side surface, an upper end surface, and a bottom surface of the body 110. In this case, it is preferable that the foreign substance injection prevention layer 120 does not enclose a lower end surface of the body 110, as shown in FIG. 2. This is because some of the plurality of metal terminals 130 is exposed at the lower end surface of the body 110.

In the foregoing description, a structure of the ear jack 100 has been described. Hereinafter, a fastening structure of the ear jack 100 and the mobile terminal is described.

Referring to FIG. 3, the ear jack 100 is fastened to a case 210 of the mobile terminal. Here, the case 210 of the mobile terminal includes an ear jack fastening portion 21 for fastening the ear jack 100. For example, the ear jack fastening portion 21 may be formed in a groove form, as designated by reference numeral 310 of FIG. 3. The case 210 may be a front case or a rear case of the mobile terminal.

Further, as designated by reference numeral 310 of FIG. 3, the ear jack 100 is mounted in an ear jack pad 140. The ear jack pad 140 performs an interface function of printed circuit boards (PCB) (not shown) that mount the plurality of metal terminals 130 and a plurality of electronic components (e.g., a sound element) of the ear jack 100. For example, the ear jack pad 140 may be connected to the PCB through a flexible printed circuit board (FPCB) (not shown).

When the ear jack 100 is fastened to the case 210 of the mobile terminal, the foreign substance injection prevention layer 120 is pressed by an inner side surface of the case 210 and the body 110, as designated by reference numeral 320 of FIG. 3. In this way, as the foreign substance injection prevention layer 120 of an elastic material is pressed, a gap does not occur between the case 210 of the mobile terminal and the ear jack 100.

When the ear jack 100 is mounted in the PCB through a production process (e.g., surface mount device (SMD), surface mount technology (SMT)) requiring operation of a high temperature (e.g., 300°), it is preferable that the foreign substance injection prevention layer 120 is made of a material (e.g., silicon rubber) for maintaining a property (elastic force) and a form without deforming up to a maximum temperature occurring in a production process.

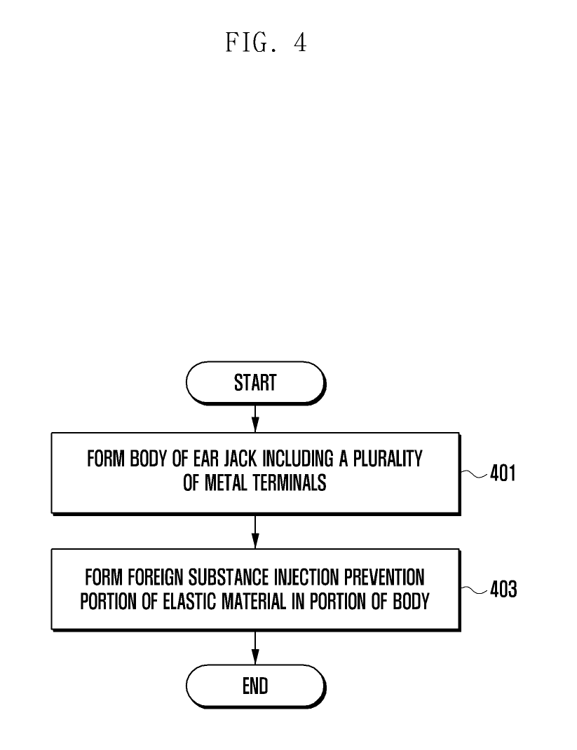

FIG. 4 is a flowchart illustrating a method of manufacturing the ear jack of FIG. 2.

Referring to FIG. 4, in a method of manufacturing an ear jack according to an exemplary embodiment of the present invention, the body 110 including a plurality of metal terminals 130 is formed through double injection molding or insert injection molding (401). The plurality of metal terminals may include a left sound terminal, a right sound terminal, a microphone terminal, a ground terminal, and a detection terminal according to a standard specification of the ear jack.

When the body 110 is formed, the foreign substance injection prevention layer 120 of an elastic material is formed in at least a portion of the body 110 through double injection molding (403). For example, the foreign substance injection prevention layer 120 may be formed to enclose a left side surface, a right side surface, an upper end surface, and a bottom surface of the body 110 while providing an opening to receive the ear jack, as shown in FIG. 2. However, the present invention is not limited thereto. That is, the foreign substance injection prevention layer 120 may be formed in various portions of the body 110 according to a designer's intention and a preferred generation portion of a gap when mounting a case.

In the foregoing exemplary embodiment, unlike the prior art, as the foreign substance injection prevention layer 120 of an elastic material for preventing a foreign substance from is integrally formed and tightly sealed with the body 110 of the ear jack 100, thus a production process of a mobile terminal can be simplified. Due to this simplification, a production cost of the mobile terminal associated with assembling an ear jack can be reduced. That is, because a separate subsidiary material is not used, a production process of the mobile terminal can be simplified, and a production cost of the mobile terminal can be reduced. Further, as the foreign substance injection prevention layer 120 is integrally formed with the body 110 of the ear jack 100, the drawbacks or problems associated with the conventional art can be prevented. Thus, according to the teachings of the present invention, a gap does not occur between the ear jack 100 and the case 210 of the mobile terminal and thus a foreign substance can be prevented from being injected thereto even when the mobile terminal is submerged in water.

Also, as a foreign substance injection prevention portion is integrally formed, a separate subsidiary material is not used, and a foreign substance (e.g., rainwater) can be prevented from being injected into the mobile terminal. Accordingly, an inundation problem according to injection of rainwater can be effectively prevented and thus user reliability on the mobile terminal can be improved.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. An ear jack of a mobile terminal, comprising:
a body for receiving an earphone and for housing a plurality of metal terminals; and
an elastic layer enclosing a portion of the body for preventing a foreign substance from being injected into the mobile terminal.

2. The ear jack of claim 1, wherein the elastic layer is tightly pressed by a case of the mobile terminal for preventing a gap between the case of the mobile terminal and the ear jack.

3. The ear jack of claim 1, wherein the elastic layer is integrally formed with the body through double injection molding.

4. The ear jack of claim 1, wherein the elastic layer substantially encloses an outer portion of the body.

5. The ear jack of claim 1, wherein the elastic layer is made of one of urethane, rubber, and silicon rubber material.

6. The ear jack of claim 1, wherein the ear jack is mounted on a separate ear jack pad for interfacing with a printed circuit board (PCB).

7. The ear jack of claim 1, wherein the ear jack is mounted in a printed circuit board (PCB) for interfacing a plurality of electronic components.

8. The ear jack of claim 7, wherein the elastic layer is made of a heat resistant material.

9. A method for providing an ear jack for a mobile terminal, comprising:
providing a body for receiving an earphone and for housing a plurality of metal terminals;
forming an elastic layer substantially enclosing a portion of the body; and
inserting the body enclosed by the elastic layer inside a casing of the mobile terminal to form a tight fit between the body and the casing.

10. The method of claim 9, further comprising mounting the body and the elastic layer on an ear jack pad which performs an interface function with a printed circuit boards (PCB).

11. The method of claim 9, wherein the elastic layer is integrally formed with the body through double injection molding.

12. The method of claim 9, wherein the elastic layer is made of one of urethane, rubber, and silicon rubber material.
